(19) United States
(12) Patent Application Publication
(10) Pub. No.: US 2012/0036838 A1
(43) Pub. Date: Feb. 16, 2012

(54) EXHAUST PURIFICATION SYSTEM FOR A VEHICLE

(75) Inventor: Yuuji Furuya, Saitama (JP)

(73) Assignee: BOSCH CORPORATION, Tokyo (JP)

(21) Appl. No.: 13/263,907

(22) PCT Filed: Jan. 15, 2010
(86) PCT No.: PCT/JP2010/050424

§ 371 Date: Oct. 11, 2011

(30) Foreign Application Priority Data
Apr. 13, 2009 (JP) 2009-097141

(51) Int. Cl. F02D 43/00

(52) U.S. Cl. 60/285

(57) ABSTRACT

To provide an exhaust purification system for a vehicle with which, even in a form of vehicle in which operation and stopping of an internal combustion engine are frequently alternated between, exhaust gas is prevented from being exhausted to the outside of the vehicle with a purification treatment remaining insufficient and an excessive drop in battery capability is prevented.

In an exhaust purification system for a vehicle equipped with purge control means for executing a purge treatment that recovers a reducing agent remaining inside a reducing agent supply section after an internal combustion engine is stopped, the purge control means executes the purge treatment in a case corresponding to at least one of a case where it has been determined that the internal combustion engine will not be restarted for a predetermined amount of time or longer when the internal combustion engine is stopped or a case where it has been determined that the stopping of the internal combustion engine is not due to control that causes the internal combustion engine to automatically stop when a predetermined idling stop condition has been met.

### BACKGROUND OF THE INVENTION

The present invention relates to an exhaust purification system that is installed in a vehicle and in which a reduction catalyst is placed inside an exhaust passageway of an internal combustion engine and which introduces a reducing agent supplied from a reducing agent supply section to the reduction catalyst together with exhaust gas to thereby perform a purification treatment of the exhaust gas. The present invention particularly relates to an exhaust purification system in which a purge treatment of the reducing agent remaining inside the reducing agent supply section when the internal combustion engine is stopped is performed.

Conventionally, as exhaust purification systems that purify nitrogen oxides in exhaust gas of a vehicle, numerous exhaust purification systems configured such that a reduction catalyst such as a selective reduction catalyst is placed inside an exhaust passageway and a reducing agent such as an aqueous solution of urea stored in a reducing agent tank is supplied by a reducing agent supply section into the exhaust passageway on the upstream side of the reduction catalyst have been known.

In such an exhaust purification system, if the reducing agent remains inside the reducing agent supply section after the internal combustion engine is stopped, troubles such as the reducing agent being concentrated or crystallizing due to evaporation of the solvent or the like and creating a clog inside the reducing agent supply section arise. For that reason, after the internal combustion engine is stopped, a purge treatment that recovers the reducing agent existing inside the reducing agent supply section in the reducing agent tank is performed (e.g., see patent document 1 listed below). It is common for the purge treatment to be performed, for example, by utilizing a pump in the reducing agent supply section to recover the reducing agent or by supplying pressurized air into the reducing agent supply section to thereby recover the reducing agent.

However, in the case of a vehicle that frequently alternates between travelling and stopping, such as a work vehicle that is used for door-to-door deliveries or the like, operation and stopping of the internal combustion engine are frequently alternated between in short periods of time. In such a work vehicle, if the purge treatment of the reducing agent supply section is set to be invariably executed when the internal combustion engine is stopped, the purge treatment becomes performed frequently every time the internal combustion engine stops.

Further, in recent years, idling stop control, which causes the internal combustion engine to stop while the vehicle is temporarily stopped, has begun to be put to practical use for the purposes of improving mileage and reducing the exhaust gas quantity and noise. In idling stop control, when a predetermined idling stop condition is realized, fuel injection is caused to stop and the internal combustion engine automatically stops, and when a predetermined restart condition is realized, fuel injection is caused to resume and the internal combustion engine restarts.

In this way, even in a vehicle that is capable of executing idling stop control by which the internal combustion engine is frequently caused to stop, if the purge treatment of the reducing agent supply section is set to be invariably executed when the internal combustion engine is stopped, the purge treatment becomes performed frequently every time the internal combustion engine stops.

When the internal combustion engine is restarted after the purge treatment, the reducing agent cannot be supplied to the reduction catalyst unless the reducing agent supply section is returned to a state where it is capable of supplying the reducing agent by, for example, refilling the inside of the reducing agent supply section with the reducing agent. For that reason, in work vehicles and vehicles that are capable of executing idling stop control, if the internal combustion engine is started immediately when the vehicle starts traveling, immediately after the internal combustion engine is restarted, the exhaust gas becomes exhausted to the outside of the vehicle with the purification treatment of the exhaust gas remaining insufficient. On the other hand, if the internal combustion engine were to be started after the reducing agent supply section is reliably returned to a state where it is capable of supplying the reducing agent when the internal combustion engine is restarted, time is required for the vehicle to reach a state where it is capable of traveling, which is not practical.

Further, when performing the purge treatment when the internal combustion engine is stopped, the electric power stored in the battery is consumed. Particularly in cold regions, sometimes a heater is used to thaw out the reducing agent when the internal combustion engine is started and to prevent the reducing agent from freezing, and the quantity of electric power consumed is remarkably large. However, in work vehicles and vehicles that are capable of executing idling stop control, it is easy for the electric energy stored in the battery to become smaller when the vehicle travels because each traveling distance and operating time from when the internal combustion engine is started to until the internal combustion engine is stopped is short. Consequently, if the purge treatment is implemented frequently, this easily creates a deficiency in the battery electric power. Moreover, in work vehicles in which starting and stopping of the internal combustion engine are frequently alternated between and vehicles that are capable of executing idling stop control, if the purge treatment is performed every time the internal combustion engine is stopped, rapid deterioration of the battery easily arises because the frequency of usage of the battery rises.

### SUMMARY OF THE INVENTION

Therefore, it is an object of the present invention to provide an exhaust purification system for a vehicle with which, even in work vehicles in which operation and stopping of an internal combustion engine are frequently alternated between and vehicles that are capable of executing idling stop control, exhaust gas is prevented from being exhausted to the outside of the vehicle with a purification treatment remaining insufficient and an excessive drop in battery capability is prevented.

According to the present invention, an exhaust purification system for a vehicle comprising a reduction catalyst that is placed inside an exhaust passageway of an internal combustion engine installed in a vehicle, a reducing agent tank that stores a reducing agent, a reducing agent supply section that supplies the reducing agent stored in the reducing agent tank to the reduction catalyst, and a control device that controls the reducing agent supply section, with the control device being equipped with purge control means for executing a purge treatment that recovers the reducing agent remaining inside the reducing agent supply section after the internal combustion engine is stopped, wherein the purge control means executes the purge treatment in a case corresponding to at least one of a case where it has been determined that the internal combustion engine will not be restarted for a predetermined amount of time or longer when the internal combustion engine is stopped or a case where it has been determined that the stopping of the internal combustion engine is not due to control that causes the internal combustion engine to automatically stop when a predetermined idling stop condition has been met; thus, the above-described problem can be solved.

Further, in configuring the exhaust purification system for a vehicle of the present invention, it is preferred that the control device is equipped with restart state determining means that discriminates that the internal combustion engine will not be restarted for a predetermined amount of time or longer when the internal combustion engine is stopped, and the purge control means executes the purge treatment in a case where it has been determined by the restart state determining means that the internal combustion engine will not be restarted for a predetermined amount of time or longer.

Further, in configuring the exhaust purification system for a vehicle of the present invention, it is preferred that the control device is equipped with a timer that counts elapsed time from when the internal combustion engine is stopped, and when the elapsed time has reached a reference time that has been set beforehand, the restart state determining means determines that the internal combustion engine will not be restarted thereafter for a predetermined amount of time or longer.

Further, in configuring the exhaust purification system for a vehicle of the present invention, it is preferred that the control device is equipped with position sensing means that is capable of sensing the position of the vehicle, and in a case where the vehicle has returned to a predetermined position that has been set beforehand and the internal combustion engine has been stopped, the restart state determining means determines that the internal combustion engine will not be restarted thereafter for a predetermined amount of time or longer.

Further, in configuring the exhaust purification system for a vehicle of the present invention, it is preferred that the vehicle is equipped with a purge switch for causing the purge control means to forcibly execute the purge treatment, and in a case where the purge switch has been switched on after the internal combustion engine is stopped, the restart state determining means determines that the internal combustion engine will not be restarted thereafter for a predetermined amount of time or longer.

Further, in configuring the exhaust purification system for a vehicle of the present invention, it is preferred that the control device is equipped with a cooling treatment means for executing a cooling treatment of the reducing agent supply means, and the purge control means makes the purge treatment executable after the cooling treatment has ended.

Further, in configuring the exhaust purification system for a vehicle of the present invention, it is preferred that in a case where a key switch of the internal combustion engine has been switched off while the internal combustion engine is stopped even in a case where it has been determined that the stopping of the internal combustion engine is due to the automatic stopping, the purge control means executes the purge treatment when it has been determined that the internal combustion engine will not be restarted for a predetermined amount of time or longer after the internal combustion engine stops or after the key switch is switched off.

Further, in configuring the exhaust purification system for a vehicle of the present invention, it is preferred that the exhaust purification system is disposed in a work vehicle that is used for door-to-door delivery work or a vehicle that is capable of executing idling stop control that performs automatic stopping and restarting of the internal combustion engine.

According to the exhaust purification system for a vehicle of the present invention, the purge control means for executing the purge treatment of the reducing agent remaining inside the reducing agent supply section after the internal combustion engine is stopped is configured to execute the purge treatment in a case corresponding to at least one of a case where it has been determined that the internal combustion engine will not be restarted for a predetermined amount of time or longer or a case where it has been determined that the stopping of the internal combustion engine is not due to control that causes the internal combustion engine to automatically stop when a predetermined idling stop condition has been met, so in a case where the internal combustion engine is restarted for a relatively short while after the internal combustion engine is stopped, the purge treatment is not performed. For that reason, in a case where operation and stopping of the internal combustion engine are frequently alternated between, time until allowing the reducing agent supply section to return to a state where it is capable of supplying the reducing agent when the internal combustion engine is restarted becomes unnecessary, the reducing agent is supplied from the reducing agent supply section to the reduction catalyst in a short amount of time after the internal combustion engine is restarted, and the purification treatment of the exhaust gas is promptly started. For that reason, in a vehicle in which operation and stopping of the internal combustion engine are frequently alternated between, exhaust gas whose purification treatment is insufficient is prevented from being exhausted to the outside of the vehicle when the internal combustion engine is restarted.

Further, in the exhaust purification system for a vehicle of the present invention, the number of times the purge treatment is executed is kept small, so in a vehicle in which operation and stopping of the internal combustion engine is alternated between and in which a lot of battery electric power is consumed, the amount of electric power that is consumed for the purge treatment is kept small and an excessive drop in battery capability is prevented. Particularly in cold regions, when the outside air temperature is low, more battery electric power becomes consumed in order to heat the reducing agent tank, but if the number of times the purge treatment is executed is kept small, the amount of electric power consumed by the purge treatment is kept small, so a shortage of battery electric power and rapid deterioration of the battery are prevented and the capacity of the battery can also be made small.

Further, in the exhaust purification system for a vehicle of the present invention, the control device is equipped with the restart state determining means that discriminates that the internal combustion engine will not be restarted for a predetermined amount of time or longer when the internal combustion engine is stopped, whereby the state where the internal combustion engine will not be restarted for a predetermined amount of time or longer is easily and reliably detected.

Further, in the exhaust purification system for a vehicle of the present invention, in a case where the elapsed time from when the internal combustion engine is stopped has reached the reference time that has been set beforehand, the restart state determining means determines that the internal combustion engine will not be restarted for a predetermined amount of time or longer, whereby it can be directly recognized on the basis of the amount of time in which the internal combustion engine is stopped that the internal combustion engine will not be restarted, and in a case where the internal combustion engine is restarted in a short amount of time after the internal combustion engine is stopped, the execution of the purge treatment is reliably prevented.

Further, in the exhaust purification system for a vehicle of the present invention, in a case where the vehicle has returned to the predetermined position that has been set beforehand, the restart state determining means determines that the internal combustion engine will not be restarted thereafter for a predetermined amount of time or longer, whereby it can be recognized on the basis of the vehicle having returned to its business office or the like and the internal combustion engine having been stopped that the internal combustion engine will not be restarted, and the execution of the purge treatment while the vehicle is running is reliably prevented.

Further, in the exhaust purification system for a vehicle of the present invention, in a case where the purge switch has been switched on, the restart state determining means determines that the internal combustion engine will not be restarted thereafter for a predetermined amount of time or longer, whereby the purge treatment can be promptly executed when notification has been given by the driver of the vehicle or the like that the internal combustion engine will not be restarted.

Further, in the exhaust purification system for a vehicle of the present invention, the purge control means executes the purge treatment after the end of the cooling treatment of the reducing agent supply section, whereby thermal damage to members whose heat proof temperature is relative low, such as the reducing agent supply section connected to the exhaust passageway and particularly a reducing agent jetting component represented by an injection valve.

Further, in the exhaust purification system for a vehicle of the present invention, in a case where the internal combustion key switch has been switched off while the internal combustion engine is stopped even in a case where it has been determined that the stopping of the internal combustion engine is due to the automatic stopping by idling stop control, the control device determines that the internal combustion engine will not be restarted for a predetermined amount of time or longer and the purge control means executes the purge treatment, whereby the purge treatment is executed after the elapse of a predetermined amount of time when the internal combustion engine has been caused to stop by the will of the driver or the like.

Further, in the exhaust purification system for a vehicle of the present invention, the exhaust purification system is disposed in a specific vehicle, whereby in a vehicle in which stopping and operation of the internal combustion engine are frequently alternated between, exhaust gas is prevented from being discharged to the outside of the vehicle with the purification treatment remaining insufficient while promptly causing the internal combustion engine to restart, and an excessive drop in battery capability is prevented.

### BRIEF DESCRIPTION OF THE DRAWINGS

FIG. 1 is a diagram showing an example configuration of an exhaust purification system for a vehicle pertaining to embodiment 1 of the present invention.

FIG. 2 is a perspective view showing a reducing agent tank that is used in the exhaust purification system for a vehicle pertaining to embodiment 1 of the present invention.

FIG. 3 is a schematic cross-sectional view of the reducing agent tank that is used in the exhaust purification system for a vehicle pertaining to embodiment 1 of the present invention.

FIG. 4 is a block diagram showing the configuration of a control device of embodiment 1 of the present invention.

FIG. 5 is a flowchart showing a control process of the control device of embodiment 1 of the present invention.

FIG. 6 is a block diagram showing the configuration of a control device of embodiment 2 of the present invention.

FIG. 7 is a flowchart showing a control process of the control device of embodiment 2 of the present invention.

### DETAILED DESCRIPTION

Embodiments pertaining to an exhaust purification system for a vehicle of the present invention will be specifically described below with reference to the drawings. However, these embodiments represent one aspect of the present invention, are not intended to limit this invention, and are capable of being arbitrarily altered in the scope of the present invention. Members to which the same reference signs have been given in the drawings represent identical members, and description thereof is appropriately omitted.

### First Embodiment

1. Overall Configuration of Exhaust Purification System for a Vehicle

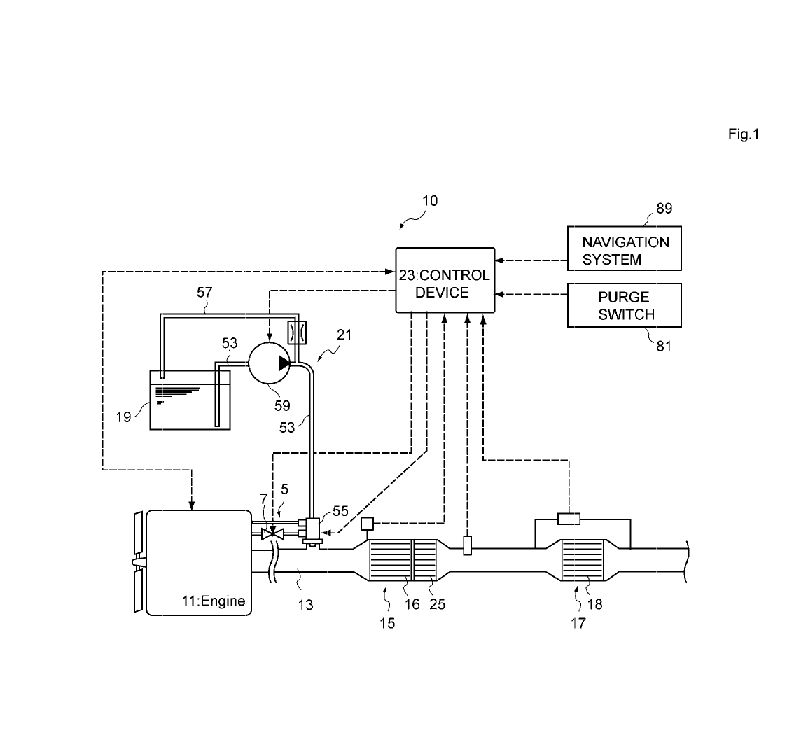

FIG. 1 shows a schematic diagram showing the overall configuration of an exhaust purification system 10. This exhaust purification system 10 is a system that purifies nitrogen oxides (NOₓ) in exhaust gas exhausted from an internal combustion engine 11 such as a diesel engine that is installed in a work vehicle such as a door-to-door delivery vehicle or a business vehicle in which operation and stopping of the internal combustion engine are frequently alternated between.

The exhaust purification system 10 is equipped with a reduction catalyst section 15 in which a reduction catalyst 16 is placed inside an exhaust passageway 13 through which the exhaust gas of the internal combustion engine 11 flows, a filter section 17 that is placed downstream of the reduction catalyst section 15 and in which a particulate filter 18 that is capable of trapping exhaust particulates in the exhaust gas is placed, a reducing agent tank 19 in which a reducing agent supplied to the reduction catalyst section 15 is stored, a reducing agent supply section 21 that injects the reducing agent stored in the reducing agent tank 19 into the exhaust passageway 13 on the upstream side of the reduction catalyst section 15, and a control device 23 that controls the reducing agent supply section 21. The reducing agent used in this exhaust purification system 10 is an aqueous solution in which a reducing component such as urea is dissolved in water, a dispersion liquid, or an aqueous liquid such as a mixture liquid.

The reduction catalyst section 15 is equipped with the reduction catalyst 16 such as a selective reduction catalyst for reducing and detoxifying NOₓ included in the exhaust gas by causing the exhaust gas to come into contact with it together with the reducing agent. In the present embodiment, this reduction catalyst section 15 is placed directly under an exhaust manifold, so no members whose heat capacity is large such as the particulate filter 18 exist on the upstream side, and it becomes possible to quickly raise the temperature of the reduction catalyst 16 to its active temperature after the internal combustion engine 11 is started.

Various sensors and so forth are placed on the upstream side and the downstream side of the reduction catalyst 16, and the temperature of the reduction catalyst 16, the NOₓ concentration in the exhaust gas, the pressure of the exhaust gas, and so forth are detected and transmitted to the control device 23. Because sensors that detect the NOₓ concentration are disposed on the upstream side and the downstream side of the reduction catalyst 16, precise control of the reducing agent injection quantity becomes possible, but it is alright if a sensor that detects the NOₓ concentration is only disposed on the downstream side of the reduction catalyst 16.

In the reduction catalyst section 15, an ammonia slip catalyst 25 is placed directly under the reduction catalyst 16, and release of ammonia is prevented. The active temperature of the ammonia slip catalyst 25 is lower than the active temperature of the reduction catalyst 16, so if the reduction catalyst 16 is in an active state, it can be judged that the ammonia slip catalyst 25 is also in an active state, so a temperature sensor is unnecessary in the ammonia slip catalyst 25.

The filter section 17 is equipped with the particulate filter 18 for trapping exhaust particulates in the exhaust gas. Here, a muffler is omitted by placing the filter section 17 immediately in front of a tailpipe of the exhaust gas passageway 13. This filter section 17 detects the cumulative amount of the trapped particulates on the basis of the difference in pressure between the upstream side and the downstream side of the filter section 17, for example, and thermal regeneration of the particulate filter 18 is performed at a predetermined time.

In the exhaust purification system 10 for a work vehicle of the present embodiment, operation and stopping of the internal combustion engine 11 are frequently alternated between during one day's work, that is, during the running period of the work vehicle, but because the entire traveling distance does not become a lot, thermal regeneration is not performed during the running period during work but is set so as to be performed forcibly when the running of the work vehicle ends, such as when the work vehicle has returned to its business office. Further, this forced thermal regeneration is configured such that an electric heater for thermal regeneration is built into the filter section 17 and is heated by an external power source, so complicated control for thermal regeneration is simplified, the number of parts becomes fewer, and the exhaust purification system is cheaply configured. Further, because fuel is not used in the thermal regeneration of the particulate filter 18, fuel consumption is suppressed, which is preferred.

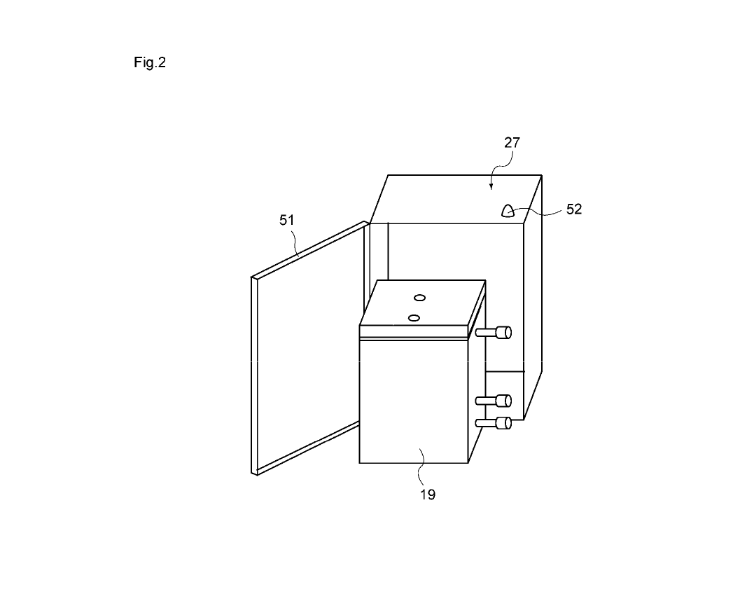

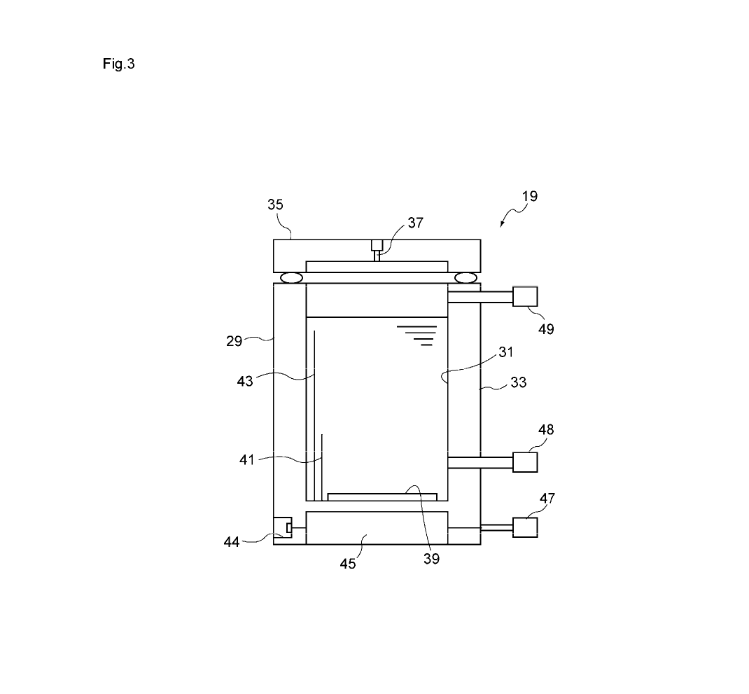

As shown in FIG. 2 and FIG. 3, the reducing agent tank 19 is detachably loaded inside a tank housing 27 that is fixed and disposed in the vehicle. This reducing agent tank 19 is formed such that its capacity is small enough to allow a user to carry the reducing agent tank 19 by hand; for example, the reducing agent tank 19 is formed in a volume for about the quantity used in one day by an exhaust purification system for a work vehicle. A tank body 29 has a dual structure and its heat insulating property is high; for example, the tank body 29 can be given a structure where an inside container 31 in which the reducing agent is stored is formed by insulated glass and the space between the inside container 31 and an outside container 33 is air-tight or can be given a structure where the inside container 31 and the outside container 33 are formed by a metal material and the space between them is filled with a heat insulating material.

A cover 35 is formed in the same dual structure as the tank body 29, and an atmospheric air introducing portion 37 that penetrates the lid 35 is disposed in a part of the lid 35. The atmospheric air introducing portion 37 is formed by placing a porous member in a through hole, for example, and is configured to be capable of introducing atmospheric air from the outside when the reducing agent has been used and the liquid level has dropped. Because the porous member is placed in this atmospheric air introducing portion 37, leakage of the reducing agent from the atmospheric air introducing portion 37 is prevented.

On the bottom portion of the reducing agent tank 19, a heater 39 for heating the reducing agent is disposed and a temperature sensor 41 and a residual quantity sensor 43 and the like are disposed. The heater 39 is configured such that it is capable of being powered by electric power from an unillustrated vehicle battery and capable of being powered by electric power from an external power source by an external power source input component 44, and the heater 39 is powered utilizing the electric power from the battery when it is installed in the vehicle and utilizing the electric power from the external power source when it has been detached from the vehicle.

In this reducing agent tank 19, it is preferable for the stored reducing agent to be maintained at a predetermined temperature in a state where it will not freeze, and a heating control component 45 for adjusting the heat quantity of the heater 39 on the basis of the detection results of the temperature sensor 41, the residual quantity sensor 43, and so forth is disposed in the lower portion of the reducing agent tank 19.

Further, in this reducing agent tank 19, a connector 47 for connecting electrical circuits such as sensors and heaters to the vehicle when the reducing agent tank 19 is installed in the vehicle is disposed, and connectors 48 and 49 for connecting an outflow line and a return line of the reducing agent to flow paths on the vehicle side are also disposed. These connectors 47 to 49 are all one-touch connectors, and workability when attaching and detaching the reducing agent tank 19 is improved. The one-touch connectors are configured such that communicating paths are formed inside in a state where the connectors have been connected to the flow paths on the vehicle side and such that the flow paths inside the connectors 47 to 49 are blocked when the connectors have been detached from the flow paths on the vehicle side.

The tank housing 27 that is fixed to the vehicle has a structure that is capable of stably fixing and housing the reducing agent tank 19, and a lockable opening-and-closing door 51 is disposed. In this tank housing 27, the opening-and-closing door 51 is configured so as to be capable of being locked and unlocked by the control device 23 because it is not preferable for the reducing agent tank 19 to become detached while the reducing agent is in use, and the control device 23 ensures that the opening-and-closing door 51 cannot be opened or closed while, for example the reducing agent during operation of the internal combustion engine 11 is consumed and during a later-described purge treatment.

A pilot lamp 52 or the like may also be disposed on the outer surface of the tank housing in order to make it easier to recognize when the opening-and-closing door 51 is locked or unlocked. For example, this pilot lamp 52 is lit up when the opening-and-closing door 51 is locked and is extinguished when the opening-and-closing door 51 is unlocked.

Because the reducing agent tank 19 of this configuration is made attachable and detachable, in cold regions and the like, it is possible to detach the reducing agent tank 19 from the vehicle and keep it warm or heat it when the vehicle stops running, and freezing of the reducing agent is easily prevented. In a case where the reducing agent is frozen, the reducing agent is easily thawed out in a relatively short amount of time by detaching the reducing agent tank 19 and using an external power source indoors or the like to thaw out the reducing agent. Further, when the reducing agent tank 19 is installed in the vehicle, it becomes possible for the reducing agent inside the reducing agent tank 19 to be maintained at a predetermined temperature with the electric power from the battery by the same heater 39.

Returning to FIG. 1, the reducing agent supply section 21 is equipped with a reducing agent jetting component 55 that is capable of jetting or spraying the reducing agent on the upstream side of the reduction catalyst section 15 inside the exhaust passageway 13, a reducing agent feed line 53 for feeding the reducing agent from the reducing agent tank 19 to the reducing agent jetting component 55, a reducing agent discharge line 57 for discharging some of the reducing agent that has been fed toward the reducing agent jetting component 55 to the reducing agent tank 19, and a feeding component 59 that is disposed in the middle of the reducing agent feed line 53.

The reducing agent feed line 53 is a pipe line formed between the reducing agent tank 19 and the reducing agent jetting component 55. A back pressure component such as an orifice or a pressure regulator for maintaining the reducing agent inside the reducing agent feed line 53 at a predetermined pressure by applying back pressure to the fed reducing agent is disposed in the reducing agent discharge line 57.

Detailed illustration of the feeding component 59 is omitted, but the feeding component 59 is equipped with a pump for pressure-feeding the reducing agent, a foreign matter filter that removes foreign matter in the reducing agent, and a flow path switching valve that switches the flow direction of the reducing agent resulting from the driving of the pump between a forward direction and a reverse direction.

Consequently, when supplying the reducing agent to the exhaust passageway 13, the flow direction of the reducing agent is switched to the forward direction leading from the reducing agent tank 19 to the reducing agent jetting component 55 so that the reducing agent can be pressure-fed to the reducing agent jetting component 55 by the driving of the pump. Further, when a purge treatment that recovers the reducing agent in the reducing agent tank 19 is implemented, the flow direction of the reducing agent is switched to the reverse direction leading from the reducing agent jetting component 55 to the reducing agent tank 19 so that the reducing agent remaining inside the reducing agent supply section 21 is recovered in the reducing agent tank 19 by the driving of the pump.

In the present embodiment, an electromagnetically controlled reducing agent injection valve is used for the reducing agent jetting component 55. This reducing agent injection valve is equipped with an electromagnetic solenoid in which a movable element is caused to move back and forth by the energization of a coil, and this electromagnetic solenoid and a resin portion configuring the housing of the reducing agent injection valve have a relative low temperature limit. For that reason, a cooling water passageway 5 through which cooling water used to cool the internal combustion engine 11 circulates is formed around the reducing agent jetting component 55 as cooling means for cooling the reducing agent jetting component 55.

The cooling water passageway 5 is configured to branch from a cooling water circulation passageway of the internal combustion engine 11 and again merge with the cooling water circulation passageway, and a cooling water flow rate adjusting valve 7 is disposed in the middle of the cooling water passageway 5. Opening-and-closing control of this cooling water flow rate adjusting valve 7 is performed by the control device 23, and control is performed such that the temperature of the reducing agent jetting component 55 is held at or below a predetermined temperature.

However, the configuration of the reducing agent supply section 21 and the configurations of the means that executes the purge treatment and the cooling means for cooling the reducing agent jetting component 55 are not limited to the above-described examples, and various changes are possible. For example, the cooling means for cooling the reducing agent jetting component 55 can also be given a configuration that causes the reducing agent to circulate such that the reducing agent is returned to the reducing agent tank 19 via the reducing agent jetting component 55 in addition to a configuration that causes the cooling water of the internal combustion engine 11 to circulate.

2. Control Device

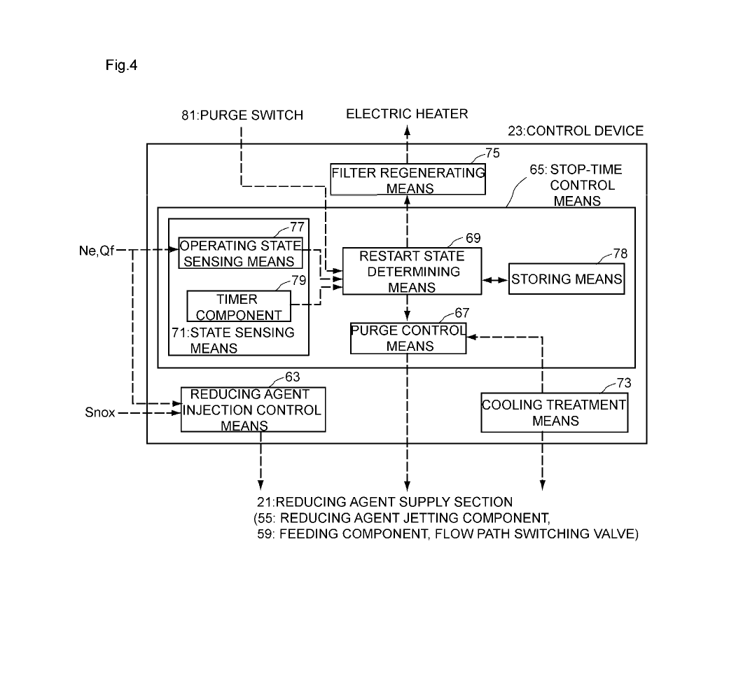

FIG. 4 is a diagram in which the configuration of the control device 23 disposed in the exhaust purification system 10 for a work vehicle of the present embodiment is represented by functional blocks. This control device 23 has reducing agent injection control means 63 that controls the action of the reducing agent supply section 21 when the internal combustion engine 11 is operating, stop-time control means 65 that controls the action of the reducing agent supply section 21 when the internal combustion engine 11 stops operating, cooling treatment means 73 for implementing a cooling treatment of the reducing agent feed line 53 of the reducing agent supply section 21, and filter regenerating means 75 for implementing forced thermal regeneration of the particulate filter. These means are specifically realized by the execution of programs by a microcomputer.

The reducing agent injection control means 63 is configured to perform injection control of the reducing agent for purifying the exhaust gas exhausted from the internal combustion engine 11 during operation of the internal combustion engine 11 and is capable of causing a quantity of the reducing agent according to the NOₓ quantity in the exhaust gas to be supplied into the exhaust gas passageway 13 from the reducing agent supply section 21 by performing action control of the feeding component 59, the reducing agent jetting component 55, and so forth on the basis of the operating state of the internal combustion engine 11, a sensor value Snox of a NOₓ sensor disposed in the exhaust passageway 13, and so forth.

The cooling treatment means 73 is configured to implement a cooling treatment of the reducing agent jetting component 55 by performing opening-and-closing control of the cooling water flow rate adjusting valve 7 disposed in the cooling water passageway 5. There are cases where the temperature of the reducing agent jetting component 55 rises because of the heat quantity remaining inside the exhaust passageway 13 not just during operation of the internal combustion engine 11 but also after the internal combustion engine 11 is stopped, so the cooling treatment means 73 is configured to execute the cooling treatment of the reducing agent supply section 21 also after the internal combustion engine 11 is stopped. Additionally, the cooling treatment means 73 outputs a cooling treatment completion signal to purge control means 67 after the completion of the cooling treatment.

The stop-time control means 65 is configured to perform control for maintaining the reducing agent supply section 21 in a predetermined state when the internal combustion engine 11 is stopped, and the stop-time control means 65 is equipped with purge control means 67 for implementing a purge treatment of the reducing agent inside the reducing agent supply section 21, restart state determining means 69 that discriminates that the internal combustion engine 11 will not be restarted for a predetermined amount of time or longer when the internal combustion engine 11 is stopped, state sensing means 71 that senses various forms of information described later and transmits the sensing results to the restart state determining means 69, and storing means 78 in which is stored information that becomes a reference for discriminating that the internal combustion engine 11 will not be restarted for a predetermined amount of time or longer.

The state sensing means 71 is equipped with operating state sensing means 77 that senses the operating state of the internal combustion engine 11 and a timer component 79 that senses elapsed time from the point in time when the internal combustion engine 11 has stopped, and the state sensing means 71 is configured such that the elapsed time that has been sensed by the timer component 79 is transmitted to the restart state determining means 69. The operating state sensing means 77 is configured such that it can at least detect that the internal combustion engine 11 has stopped. The stopping of the internal combustion engine can be configured such that it is detected, for example, when an engine speed Ne has become zero or equal to or lower than a predetermined value or when an off signal of a key switch of the internal combustion engine 11 has been detected. Further, a purge switch 81 for causing the purge treatment to be executed is disposed in the driver seat or the like of the vehicle, and the input from this purge switch 81 is configured to be transmitted to the restart state determining means 69.

The purge control means 67 is configured to execute, after the internal combustion engine 11 is stopped, the purge treatment by which the reducing agent remaining inside the reducing agent supply section 21 is returned to the reducing agent tank 19 by closing the reducing agent jetting component 55, switching the flow direction of the reducing agent to the reverse direction with the flow path switching valve, and operating the pump.

In the storing means 78, a reference time for determining, by the elapsed time after the internal combustion engine 11 stops, that the internal combustion engine 11 will not be restarted thereafter for a predetermined amount of time or longer is stored beforehand. The reference time from when the internal combustion engine 11 is stopped that is stored beforehand is not particularly limited and is set to a desired time; for example, it is preferable to set the reference time to 5 minutes to 20 minutes in the case of a work vehicle in which operation and stopping of the internal combustion engine 11 are frequently alternated between.

The restart state determining means 69 is configured to discriminate that the internal combustion engine 11 will not be restarted for a predetermined amount of time or longer on the basis of signals transmitted from the timer component 79 and the purge switch 81 and, when it has been determined that the internal combustion engine 11 will not be restarted, output a purge treatment start signal for starting the execution of the purge treatment to the purge control means 67 immediately thereafter or after the elapse of an appropriate amount of time.

Here, the predetermined amount of time in which the internal combustion engine will not be restarted is an amount of time in which it can be judged that travel by the work vehicle will not be performed for a long amount of time as a result of the work vehicle ending a run or the driver entering a prolonged rest.

In the present embodiment, when the elapsed time from when the internal combustion engine 11 is stopped has reached the reference time that is stored beforehand in the storing means 78 or when the purge switch has been switched on when the internal combustion engine 11 is stopped, the restart state determining means 69 discriminates that the internal combustion engine 11 will not be restarted thereafter for the predetermined amount of time or longer.

Further, in the present embodiment, separate from the determination by the restart state determining means 69, the purge treatment is not started by the purge control means 67 until the cooling treatment of the reducing agent supply section 21 by the cooling treatment means 73 is completed. Consequently, after the completion of this cooling treatment, the execution of the purge treatment is started when it is determined by the restart state determining means 69 that the internal combustion engine 11 will not be restarted for the predetermined amount of time or longer.

The filter regenerating means 75 is, like the purge control means 67, configured to energize the electric heater disposed in the filter section 17 when it has been discriminated that the internal combustion engine 11 will not be restarted for the predetermined amount of time or longer and to perform thermal regeneration of the particulate filter 18.

3. Action of Exhaust Purification System when Supplying Reducing Agent

In the exhaust purification system 10 of the configuration that has been heretofore described, during normal operation of the internal combustion engine 11, the action of the reducing agent supply section 21 is controlled by the reducing agent injection control means 63 of the control device 23 on the basis of information of the various sensors and the operating state of the internal combustion engine 11, and an exhaust purification treatment is performed.

When the internal combustion engine 11 is operating, the reducing agent stored in the reducing agent tank 19 is supplied to the reducing agent jetting component 55 at a predetermined pressure, and in this state the opening and closing of the reducing agent jetting component 55 is controlled, whereby the reducing agent is jetted and is supplied to the upstream side of the reduction catalyst section 15 inside the exhaust passageway 13. This reducing agent contacts the reduction catalyst 16 together with the exhaust gas from the internal combustion engine 11, the NOₓ in the exhaust gas is reduced, and a detoxifying treatment is performed.

4. Purge Control Method

Further, in the exhaust purification system 10 of the configuration described above, purge control is performed by the stop-time control means 65 when the internal combustion engine 11 is stopped.

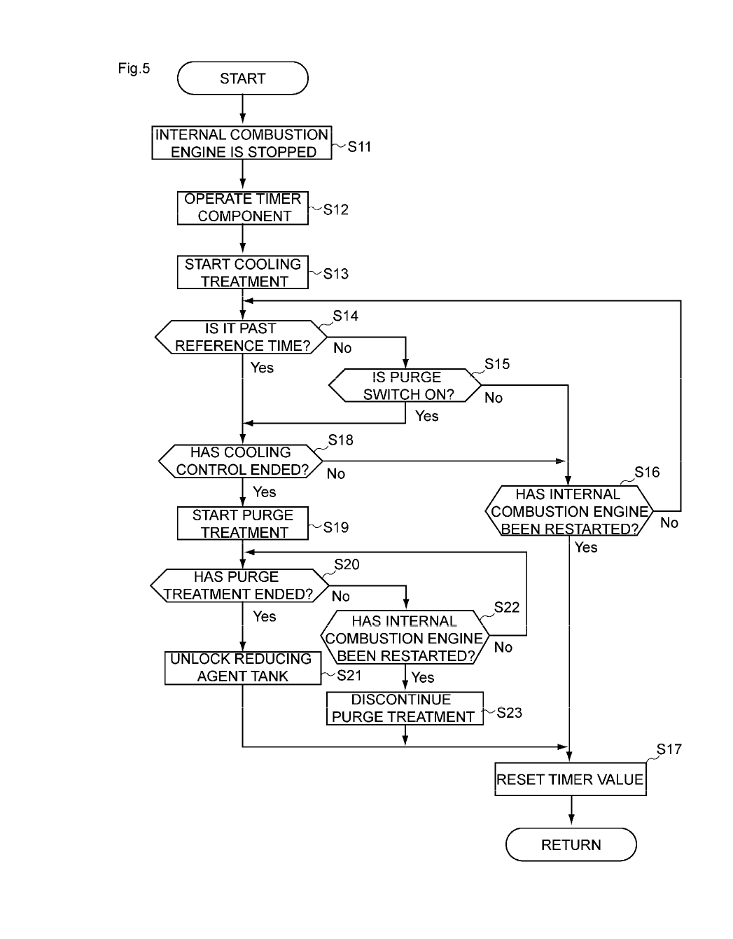

FIG. 5 shows one example of a control flow of a purge control method that is performed by the control device 23 of the exhaust purification system 10 of the present embodiment. First, when the stopping of the internal combustion engine 11 is sensed on the basis of the engine speed or the off signal of the key switch in step S11, the timer component 79 starts operating in step S12 and the cooling treatment of the reducing agent supply section 21 is started in step S13.

Next, in step S14, it is discriminated whether or not the elapsed time counted by the timer component 79 has gone past the reference time; in a case where the elapsed time has gone past the reference time, the control flow advances to step S18, and in a case where the elapsed time has not gone past the reference time, the control flow advances to step S15. In step S15, it is determined whether or not the purge switch 81 is switched on; in a case where the purge switch 81 is switched on, the control flow advances to step S18, and in a case where the purge switch 81 is off, the control flow advances to step S16.

Then, in step S16, it is discriminated whether or not the internal combustion engine 11 has been restarted; if the internal combustion engine 11 has not been restarted, the control flow returns to step S14, and when the internal combustion engine 11 has been restarted, the count of the timer component 79 is reset in step S17 and the present routine is ended.

In step S18, to which the control flow has advanced when the elapsed time counted by the timer component 79 has gone past the reference time in step S14 or when the purge switch 81 is switched on in step S15, it is discriminated whether or not the cooling treatment of the reducing agent supply section 21 is completed. If the cooling treatment is not completed, the control flow advances to S16 where it is discriminated whether or not the internal combustion engine 11 is restarting, and in a case where the cooling treatment is completed, the control flow advances to step S19.

In step S19, the execution of the purge treatment is started, and next, in step S20, it is discriminated whether or not the purge treatment is completed. If the purge treatment is completed, the control flow advances to step S21 where the tank housing 27 in which the reducing agent tank 19 is housed is unlocked and the pilot lamp 53 is extinguished, and thereafter the count of the timer component 79 is reset in step S17 and the present routine is ended. If the purge treatment is not completed, the control flow advances to step S22 where it is discriminated whether or not the internal combustion engine 11 has been restarted.

If the internal combustion engine 11 has not been restarted, the control flow returns to step S20, and when the internal combustion engine 11 is being restarted, the purge treatment is discontinued in step S23, the count of the timer component 79 is reset in step S17, and the present routine is ended.

In a case where the routine has been ended in a state where the purge treatment has been completed, it becomes possible for the driver or the like to detach the reducing agent tank 19 from the tank housing 27 and keep the reducing agent tank 19 indoors or the like in order to prevent the reducing agent inside the reducing agent tank 19 from freezing until the internal combustion engine 11 is started when starting the next business on the following day or the like, for example. Then, on the next vehicle run the reducing agent tank 19 is again loaded in the tank housing 27 and provided for use.

According to the purge control method above, the control device 23 is equipped with the purge control means 67 for executing the purge treatment of the reducing agent remaining inside the reducing agent supply section 21 in the period when the internal combustion engine 11 is stopped and the restart state determining means 69 that discriminates that the internal combustion engine 11 will not be restarted for the predetermined amount of time or longer when the internal combustion engine 11 is stopped, so in a case where the frequency of alternation between operation and stopping of the internal combustion engine 11 is high like in a work vehicle, the purge treatment is prevented from being executed every time the internal combustion engine 11 stops.

For that reason, time until the reducing agent supply section 21 returns to a state where it is capable of supplying the reducing agent becomes unnecessary when the internal combustion engine 11 is restarted in a short amount of time after having been stopped, the reducing agent is supplied from the reducing agent supply section 21 to the reduction catalyst section 15 promptly after the internal combustion engine 11 is restarted, and the purification treatment of the exhaust gas is started in a short amount of time. Consequently, even in a vehicle in which operation and stopping of the internal combustion engine 11 are frequently alternated between, exhaust gas whose purification treatment is insufficient is prevented from being exhausted to the outside of the vehicle.

Further, the number of times the purge treatment is executed is kept small, so in a vehicle in which operation and stopping of the internal combustion engine 11 is alternated between and in which a lot of battery electric power is consumed, the amount of electric power that is consumed for the purge treatment is kept low and an excessive drop in battery capability is prevented. Particularly in cold regions, when the outside air temperature is low, more battery electric power becomes consumed in order to heat the reducing agent tank 19, but if the number of times the purge treatment is executed is kept small, the amount of electric power consumed by the purge treatment is kept small and an excessive drop in battery capability in cold regions is prevented.

### Second Embodiment

In an exhaust purification system for a vehicle pertaining to a second embodiment of the present invention, determination factors of restart state determining means 169 of the control device 23 include not only the elapsed time from when the internal combustion engine 11 is stopped and whether the purge switch 81 is on or off like in the first embodiment but also the addition of the vehicle having returned to a predetermined position that has been set beforehand. In the present embodiment also, an exhaust purification system that is disposed in a work vehicle such as a door-to-door delivery vehicle or a business vehicle will be taken as an example and described.

1. Control Device

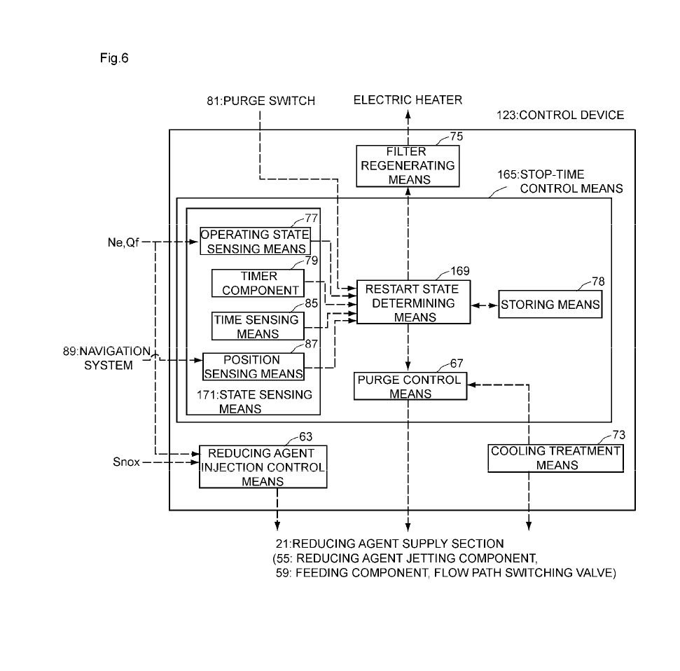

FIG. 6 is a diagram in which the configuration of a control device 123 of the present embodiment is represented by functional blocks. This control device 123 has, in state sensing means 171 of stop-time control means 165, the operating state sensing means 77 like in the control device 23 of the first embodiment and is further equipped with time sensing means 85 that senses time and position sensing means 87 that senses the position of the vehicle.

The position sensing means 87 is configured to acquire position information indicating the current position of the vehicle from a navigation system 89 or the like installed in the work vehicle and transmit the position information to the restart state determining means 169. Further, the time sensing means 85 is configured to sense the current time from a clock disposed in the work vehicle or a clock included in the configuration of the time sensing means 85 and transmit the current time to the restart state determining means 169.

Further, in the storing means 78, a scheduled shutdown position of the work vehicle is recorded beforehand and a scheduled shutdown time using the work vehicle is also recorded beforehand. Here, the scheduled shutdown position can be appropriately set so that, for example, in the case of a door-to-door delivery vehicle, the scheduled shutdown position is a business office or a storage location of the vehicle. Further, multiple positions can also be recorded as scheduled shutdown positions. Further, the scheduled shutdown time can be appropriately set so that, for example, in the case of a door-to-door delivery vehicle, the scheduled shutdown time is the scheduled time of return to the business office or a time when a rest starts. Further, several times can also be set as scheduled shutdown times.

Additionally, the restart state determining means 169 is configured to discriminate that the internal combustion engine 11 will not be restarted for a predetermined amount of time or longer on the basis of signals transmitted from the time sensing means 85, the position sensing means 87, and the purge switch 81 and, when it has been determined that the internal combustion engine 11 will not be restarted, output a purge treatment start signal for starting the execution of the purge treatment to the purge control means 67 immediately thereafter or after the elapse of an appropriate amount of time.

That when the purge switch 81 has been switched on, it is determined that the internal combustion engine 11 will not be restarted thereafter for the predetermined amount of time or longer is the same as in the first embodiment. In the present embodiment, it is also determined that the internal combustion engine 11 will not be restarted for the predetermined amount of time or longer when the work vehicle has returned to the scheduled shutdown position after the scheduled shutdown time that has been set beforehand and the internal combustion engine 11 has been stopped.

The configurations of the means other than those that have been described here are the same as those in the control device 23 of the first embodiment, so description thereof will be omitted.

2. Purge Control Method

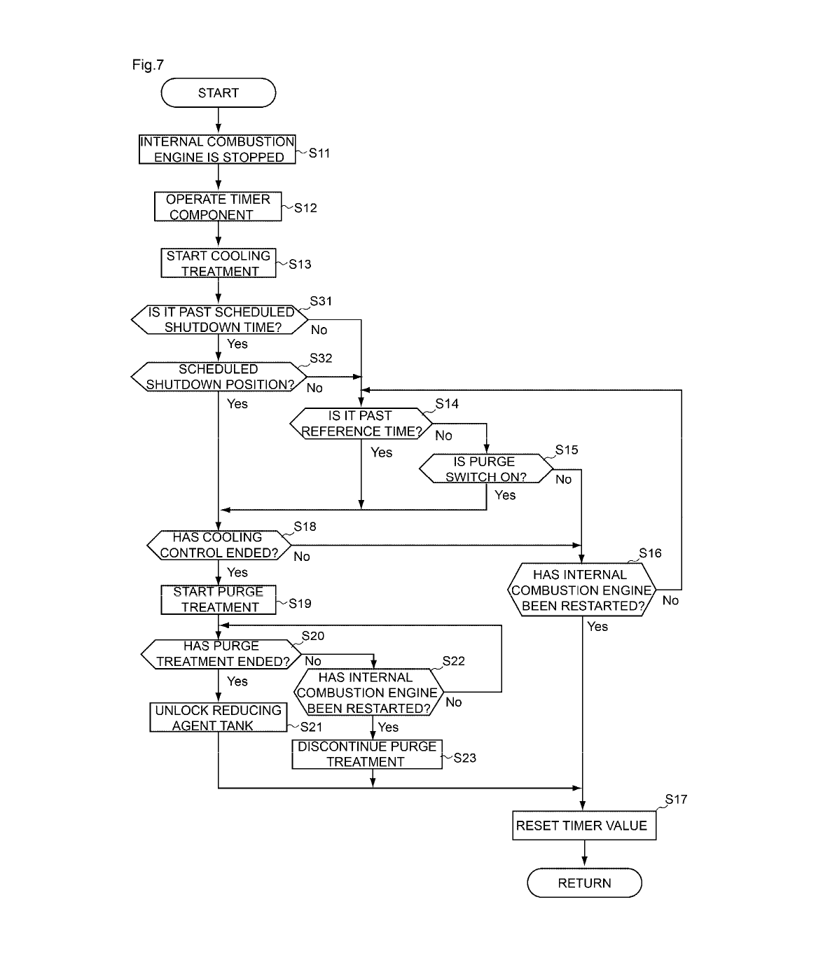

FIG. 7 shows one example of a control flow of a purge control method that is performed by the control device 123 of the exhaust purification system 10 of the present embodiment. First, like in the control flow of the first embodiment, when the stopping of the internal combustion engine 11 is sensed in step S11, the timer component 79 starts operating in step S12 and the cooling treatment of the reducing agent supply section 21 is started in step S13.

Next, in the control flow of the present embodiment, in step S31 it is discriminated whether or not the current time has gone past the scheduled shutdown time; in a case where the current time has not gone past the scheduled shutdown time, the control flow advances to step S14, and in a case where the current time has gone past the scheduled shutdown time, the control flow advances to step S32 where it is discriminated whether or not the current position of the work vehicle is in the scheduled shutdown position. In a case where the current position of the work vehicle is in the scheduled shutdown position, the control flow advances to step S18, and in a case where the current position of the work vehicle is not in the scheduled shutdown position, the control flow advances to step S14. Then, after step S14 and step S18, the control flow advances like in the steps described in the first embodiment.

That is, in the control flow of the present embodiment, not only are there step S14 that discriminates whether or not the reference time has elapsed from the stopping of the internal combustion engine 11 and step S15 that discriminates whether or not the purge switch is switched on, but step S31 and step S32 are newly added, and even when the current time has gone past the scheduled shutdown time and the current position of the work vehicle is in the scheduled shutdown position, it is discriminated that the internal combustion engine 11 will not be restarted for a predetermined amount of time or longer and the execution of the purge treatment is started.

Even in the purge control method of the present embodiment described above, the same action and effects as in the first embodiment are obtained. Particularly in the present embodiment, the restart state determining means 169 determines that the internal combustion engine 11 will not be restarted for the predetermined amount of time or longer when the work vehicle has returned to the scheduled shutdown position that has been set beforehand, so the position at which the purge treatment is to be performed is specified, and the purge treatment during work is reliably prevented.

Moreover, here, whether the current time has gone past the scheduled shutdown time is also determined by the time sensing means 85, so in a case where the vehicle returns to the scheduled shutdown position such as a business office to pick up a load in the middle of door-to-door delivery work such as in the case of a door-to-door delivery vehicle, the purge treatment is no longer performed.

### Third Embodiment

An exhaust purification system for a vehicle pertaining to a third embodiment of the present invention is an exhaust purification system disposed in a vehicle that is capable of executing idling stop control that performs automatic stopping and restarting of the internal combustion engine. The exhaust purification system pertaining to the present embodiment can be configured like the exhaust purification systems described in the first embodiment and the second embodiment with the exception of the configuration of the control device, so the configuration of the control device, which is what differs from the first embodiment and the second embodiment, will be centrally described below.

The control device configuring the exhaust purification system of the present embodiment is equipped with idling stop condition realization detecting means and restart condition realization detecting means in addition to each of the means of the control device of the first embodiment or the control device of the second embodiment or instead of the restart state determining means configuring the control device of the first embodiment or the control device of the second embodiment. Each of these means is also specifically realized by the execution of programs by a microcomputer.

When the idling stop condition realization detecting means detects the realization of a predetermined idling stop condition, the idling stop condition realization detecting means causes fuel injection to the internal combustion engine to stop and causes the internal combustion engine to automatically stop. When the realization of the idling stop condition is detected by this idling stop condition realization detecting means, a stop condition realization signal is sent to the stop-time control means.

The idling stop condition can be when at least one or more conditions—such as, for example, an engine switch being in an on state, the detected position of a gear sensor being neutral, the detected position of a brake pedal sensor being in a stepped-on state, the engine speed being equal to or less than a predetermined threshold value, and a state where the vehicle speed is 0 having continued for a predetermined amount of time or longer—are met, but the idling stop condition is not restricted to this.

Further, when the restart condition realization detecting means detects the realization of a predetermined restart condition while the internal combustion engine is in the automatically stopped state, the restart condition realization detecting means causes fuel injection to the internal combustion engine to resume and causes the internal combustion engine to restart. When the realization of the restart condition is detected by the restart condition realization detecting means, a start condition realization signal is sent to the stop-time control means.

The restart condition can be when several conditions—such as the detected position of the gear sensor having been released from the neutral state and the accelerator pedal having been stepped on—are met while the internal combustion engine is in the automatically stopped state, but the restart condition is not restricted to this.

Additionally, the stop-time control means prohibits the purge treatment by the purge control means when the stop-time control means has received the stop condition realization signal. Consequently, in the control device of the present embodiment configured in this way, in a case where the stopping of the internal combustion engine is automatic stopping due to idling stop control, the purge treatment is prohibited regardless of that stop time. The prohibition of the purge treatment during automatic stopping of the internal combustion engine due to idling stop control is lifted when the stop-time control means has received a restart condition realization signal.

Further, during automatic stopping of the internal combustion engine due to idling stop control, even when the key switch of the internal combustion engine has been switched off before the restart condition is realized, the prohibition of the purge treatment by the stop-time control means is lifted. In this case, in a case where the restart state determining means is not disposed, the purge treatment is promptly executed, and in a case where the restart state determining means is disposed, in accordance with the flow described in the first embodiment or the second embodiment the execution of the purge treatment is started when it has been determined that the internal combustion engine will not be restarted for a predetermined amount of time or longer from the point in time either when the internal combustion engine is stopped or when the key switch has been switched off.

As described above, in the control device of the present embodiment, in a case where automatic stopping and restarting of the internal combustion engine are executed by idling stop control, the control device is maintained in a state where supply of the reducing agent from the reducing agent supply section is possible until the realization of the restart condition, so the exhaust gas is prevented from being exhausted to the outside of the vehicle with the purification remaining insufficient even if the internal combustion engine is promptly restarted. Further, the purge treatment is not frequently executed every time the internal combustion engine is automatically stopped by idling stop control, so an excessive drop in battery capability is prevented.

1-8. (canceled)

9. An exhaust purification system for a vehicle comprising a reduction catalyst that is placed inside an exhaust passageway of an internal combustion engine installed in a vehicle, a reducing agent tank that stores a reducing agent, a reducing agent supply section that supplies the reducing agent stored in the reducing agent tank to the reduction catalyst, and a control device that controls the reducing agent supply section, with the control device being equipped with purge control means for executing a purge treatment that recovers the reducing agent remaining inside the reducing agent supply section after the internal combustion engine is stopped, wherein
the purge control means executes the purge treatment in a case corresponding to at least one of a case where it has been determined that the internal combustion engine will not be restarted for a predetermined amount of time or longer when the internal combustion engine is stopped.

10. The exhaust purification system for a vehicle according to claim 9, wherein
the control device is equipped with restart state determining means that discriminates that the internal combustion engine will not be restarted for a predetermined amount of time or longer when the internal combustion engine is stopped, and
the purge control means executes the purge treatment in a case where it has been determined by the restart state determining means that the internal combustion engine will not be restarted for a predetermined amount of time or longer.

11. The exhaust purification system for a vehicle according to claim 10, wherein
the control device is equipped with a timer that counts elapsed time from when the internal combustion engine is stopped, and
in a case where the elapsed time has reached a reference time that has been set beforehand, the restart state determining means determines that the internal combustion engine will not be restarted thereafter for a predetermined amount of time or longer.

12. The exhaust purification system for a vehicle according to claim 10, wherein
the control device is equipped with position sensing means that is capable of sensing the position of the vehicle, and
in a case where the vehicle has returned to a predetermined position that has been set beforehand and the internal combustion engine has been stopped, the restart state determining means determines that the internal combustion engine will not be restarted thereafter for a predetermined amount of time or longer.

13. The exhaust purification system for a vehicle according to claim 10, wherein
the vehicle is equipped with a purge switch for causing the purge control means to forcibly execute the purge treatment, and
in a case where the purge switch has been switched on after the internal combustion engine is stopped, the restart state determining means determines that the internal combustion engine will not be restarted thereafter for a predetermined amount of time or longer.

14. The exhaust purification system for a vehicle according to claim 9, wherein
the control device is equipped with a cooling treatment component for executing a cooling treatment of the reducing agent supply section, and
the purge control means makes the purge treatment executable after the cooling treatment has ended.

15. The exhaust purification system for a vehicle according to claim 9, wherein in a case where a key switch of the internal combustion engine has been switched off while the internal combustion engine is stopped, the purge control means executes the purge treatment when it has been determined that the internal combustion engine will not be restarted for a predetermined amount of time or longer after the internal combustion engine stops.

16. The exhaust purification system for a vehicle according to claim 9, wherein in a case where a key switch of the internal combustion engine has been switched off while the internal combustion engine is stopped, the purge control means executes the purge treatment after the key switch is switched off.

17. The exhaust purification system for a vehicle according to claim 9, wherein the exhaust purification system is disposed in a work vehicle that is used for door-to-door delivery work.

18. The exhaust purification system for a vehicle according to claim 9, wherein the exhaust purification system is disposed in a vehicle that is capable of executing idling stop control that performs automatic stopping and restarting of the internal combustion engine.

19. An exhaust purification system for a vehicle comprising a reduction catalyst that is placed inside an exhaust passageway of an internal combustion engine installed in a vehicle, a reducing agent tank that stores a reducing agent, a reducing agent supply section that supplies the reducing agent stored in the reducing agent tank to the reduction catalyst, and a control device that controls the reducing agent supply section, with the control device being equipped with purge control means for executing a purge treatment that recovers the reducing agent remaining inside the reducing agent supply section after the internal combustion engine is stopped, wherein
the purge control means executes the purge treatment in a case corresponding to at least one of a case where it has been determined that the internal combustion engine will not be restarted for a predetermined amount of time or longer where it has been determined that the stopping of the internal combustion engine is not due to control that causes the internal combustion engine to automatically stop when a predetermined idling stop condition has been met.

20. The exhaust purification system for a vehicle according to claim 19, wherein
the control device is equipped with restart state determining means that discriminates that the internal combustion engine will not be restarted for a predetermined amount of time or longer when the internal combustion engine is stopped, and
the purge control means executes the purge treatment in a case where it has been determined by the restart state determining means that the internal combustion engine will not be restarted for a predetermined amount of time or longer.

21. The exhaust purification system for a vehicle according to claim 20, wherein
the control device is equipped with a timer that counts elapsed time from when the internal combustion engine is stopped, and
in a case where the elapsed time has reached a reference time that has been set beforehand, the restart state determining means determines that the internal combustion engine will not be restarted thereafter for a predetermined amount of time or longer.

22. The exhaust purification system for a vehicle according to claim 20, wherein
the control device is equipped with position sensing means that is capable of sensing the position of the vehicle, and
in a case where the vehicle has returned to a predetermined position that has been set beforehand and the internal combustion engine has been stopped, the restart state determining means determines that the internal combustion engine will not be restarted thereafter for a predetermined amount of time or longer.

23. The exhaust purification system for a vehicle according to claim 20, wherein
the vehicle is equipped with a purge switch for causing the purge control means to forcibly execute the purge treatment, and
in a case where the purge switch has been switched on after the internal combustion engine is stopped, the restart state determining means determines that the internal combustion engine will not be restarted thereafter for a predetermined amount of time or longer.

24. The exhaust purification system for a vehicle according to claim 19, wherein
the control device is equipped with a cooling treatment component for executing a cooling treatment of the reducing agent supply section, and
the purge control means makes the purge treatment executable after the cooling treatment has ended.

25. The exhaust purification system for a vehicle according to claim 19, wherein in a case where a key switch of the internal combustion engine has been switched off while the internal combustion engine is stopped, the purge control means executes the purge treatment when it has been determined that the internal combustion engine will not be restarted for a predetermined amount of time or longer after the internal combustion engine stops.

26. The exhaust purification system for a vehicle according to claim 19, wherein in a case where a key switch of the internal combustion engine has been switched off while the internal combustion engine is stopped, the purge control means executes the purge treatment after the key switch is switched off.

27. The exhaust purification system for a vehicle according to claim 19, wherein the exhaust purification system is disposed in a work vehicle that is used for door-to-door delivery work.

28. The exhaust purification system for a vehicle according to claim 19, wherein the exhaust purification system is disposed in a vehicle that is capable of executing idling stop control that performs automatic stopping and restarting of the internal combustion engine.
